(19) United States
(12) Patent Application Publication
(10) Pub. No.: US 2009/0284962 A1
(43) Pub. Date: Nov. 19, 2009

(54) Portable security assessment device

(75) Inventors: William J. Grothe, Mission Viejo, CA (US); Paul E. Robbins, Mission Viejo, CA (US); James R. Zarian, Corona del Mar, CA (US)

Correspondence Address: James R. Zarian, 74 Icon, Foothill Ranch, CA, 92610, US

(73) Assignee: Lumenyte International Corporation

(21) Appl. No.: 12/453,400

(22) Filed: May 11, 2009

Related U.S. Application Data
(60) Provisional application No. 61/071,765, filed on May 16, 2008.

(51) Int. Cl. F21L 4/02

(52) U.S. Cl. 362/184

(57) ABSTRACT

A readily portable handheld security assessment device that may be manipulated for viewing the underside of objects having low ground clearance, including a series of solid state light sources distributed around the perimeter of therein mirror for uniformly illuminating the field to be viewed. A flexible ball joint assembly allows a reflector or mirror to be easily and controllably positioned and oriented under the object to facilitate visual inspection thereof while permitting the user to remain erect.

### CROSS REFERENCE TO RELATED APPLICATIONS

This application claims the benefit of the earlier filing date of U.S. Provisional Application Ser. No. 61/071,765, filed in the U.S. Patent and Trademark Office on May 16, 2008, the entire contents of which are incorporated herein by reference.

### TECHNICAL FIELD

The present invention is directed to a portable device that may be used for viewing the underside of objects having low ground clearance such as vehicles, containers and fixed or mobile equipment, to facilitate inspection thereof. The present invention may also be used to view the interior of hollow vessels, having an accessible opening, such as tanks or vaults.

The portable device of the present if used inspection and may use illumination sources in the visible range, or may use illumination sources for night vision or may use illumination sources for inspection of certain substances using certain other radiations, for example, ultraviolet range.

### BACKGROUND ART

In the field of security, and more particularly in regard to inspection of vehicles and objects having low ground clearance, especially the undersides of vehicles, it is well known to raise the vehicle up off the ground through use of a ramp, or hydraulic lift, or the like, as well as to maneuver the vehicle astraddle a well or pit in which an inspector is stationed where inspection is performed. Also, inspection can be performed with the inspector kneeling or crawling underneath the vehicle or object and inspecting the underside thereof through use of a conventional flash light for normal inspection.

In regard to inspection of hollow vessels or enclosed spaces, it is known to introduce a source of illumination such as a conventional hand-held flash light into the space to be inspected. In such instances, some or all of the inspector's person may enter into the space as well. Conducting an inspection in such a manner may expose the inspector to the atmosphere within the vessel or enclosed space that may contain toxic or inflammable compounds.

Heretofore it is believed to be unknown to use a readily portable handheld inspection device in which a flexible ball joint assembly allows a reflector or mirror to be easily and controllably manipulated underneath a vehicle, or other object having low ground clearance, or within a hollow vessel or enclosed space, to provide the operator a view of the underside of the vehicle or object, or the interior of a hollow vessel or enclosed space, as the device is manipulated to visually scan the underside of the vehicle or object, or the interior of a vessel. In one embodiment, a series of solid-state light source (light emitting diodes) are arranged in a linear configuration, and sections of such linear configurations are distributed adjacent the perimeter of the reflector and energized, to direct light evenly toward the viewed area to illuminate the underside of a vehicle or other object, or interior of an enclosed space. In such embodiments LEDs with radiation in the visible range are used.

In yet another embodiment, to protect the inspectors from being detected by unfriendly personnel, LEDs in the infrared and/or far infrared range may be used. As is well known in the art, such radiations allow inspection using night vision equipment without being easily detected by unfriendly personnel that do not possess such night vision equipment.

In yet another embodiment, to be able to inspect for dangerous substances or leakage of certain substances, LEDs in the ultraviolet range may be used. As is well known in the art, such radiations allow inspection of certain elements as may be desired.

In yet another embodiment, the evenly distributed light emitting diodes (LEDs) are encased within a translucent or transparent polymer enclosure, and placed adjacent the perimeter of the reflector and energized, to direct light evenly toward the viewed area to illuminate the underside of a vehicle or other object, or interior of an enclosed space.

In such embodiments, a power source, such as a re-chargeable battery provides power to the linear sections of LEDs. A switching mechanism is also provided to readily turn the LEDs on and off. As will be shown the power from the power source is conducted via wires to the LEDs

### BRIEF DESCRIPTION OF THE DRAWINGS

Detailed drawings of the present invention are shown in the attached Figures, in which:

FIG. 1 is a top view of the illuminating embodiment of the present invention.

FIG. 2 is a perspective view of the illuminating embodiment of the present invention with LEDs mounted on the perimeter of the mirror.

### DISCLOSURE OF INVENTION

In accordance with the principles of the present invention, a portable handheld inspection device is provided in which a flexible ball joint assembly coupled with a substantially flat planar reflector or mirror is adapted for inspection of areas that are inconvenient and/or difficult to visually inspect, such as, for example, the underside of objects having low ground clearance and the underside of vehicles. The manually manipulateable reflector facilitates visually scanning the underside of such objects and vehicles. Where ambient light levels—from natural or artificial sources—alone are adequate to permit inspection, an embodiment of the present invention having no incorporated source of illumination may be utilized. However, it is known that ambient light levels underneath a vehicle or other object having low ground clearance often do not permit a thorough visual inspection of the underside of such objects and vehicles, or the interior of enclosed spaces. In such conditions, an embodiment of the present invention incorporating a light source such as a series of LEDs with radiation in the visible range (above 400 to near 660 nm wavelength) is preferred to permit a thorough visual inspection of such difficult and/or inconvenient to inspect areas. In this embodiment, the shaft of the handle for manipulating the device and to which the mirror or reflector is movably attached may also include an energy source such as a battery pack. The power from the battery pack is transmitted to the series of LEDs by electric wires that extend along the interior of the hollow shaft of the handle and exits the shaft near its attachment with the flexible ball joint assembly, and directly attaches to the LED arrangement. When the battery pack is switched on, power is transmitted along the length of the wire, which energizes the series of LEDs around the perimeter of the mirror or reflector to provide a steady source of uniform illumination for the inspection area.

In accordance with the principles of the present invention, LEDs with radiation in the infrared or far infrared range (IR) with a wavelength above 660 nm can be used. Such radiation allows night vision using different generations of night vision equipment as well known in the art; while protecting the friendly personnel from being detected by unfriendly personnel.

In accordance with the principles of the present invention, LEDs with radiation in wavelengths below 400 nm can be used. Such radiation causes many substances to glow or fluoresce. The use of such radiations, commonly known as ultra violet (UV) light, in the field of security is well known in the art.

In accordance with the principles of the present invention, the embodiment of the present can include switching means to switch between the radiations as desired. For example, the embodiment may include LEDs radiating in wavelengths below 400 nm (UV) and include LEDs radiating in the visible range; whereby the personnel can switch from visible to UV and vice versa.

The preferred series of LEDs are normally pre-assembled on a printed circuit board (PCB) to facilitate assembly. It is noted that the PCB can be rigid, semi-rigid or flexible.

In each embodiment of the present invention, manipulation and positioning of the inspection mirror is facilitated by the flexible ball joint coupling joining the handle shaft and the inspection mirror mounting plate. The flexible ball joint permits the inspection mirror mounting plate to be continuously adjusted over a range or arc of more than about 90° with respect to the long axis of the handle shaft. That is, the inspection mirror mounting plate may be adjusted to define any angle between about perpendicular to the handle axis and about parallel to the handle axis. The flexible ball joint or knuckle is preferably fabricated of a polymeric material having a relatively low coefficient of friction, such as, for example, a variety of nylon formulations such as Nylon 6-6, a variety of polyolefin's such as polypropylene, and fluoropolymers such as fluorinated ethylene propylene (FEP) and the like to facilitate positioning the inspection mirror under the object or vehicle to be inspected when the knuckle is placed in contact with the ground. Additionally, the knuckle is shaped to allow the inspection mirror to be easily pitched and rolled to facilitate inspection when the knuckle is rested on the ground or other surface. Optional wheel(s) may further be attached to the bottom of the mirror to facilitate the movement of the mirror.

Various of the components of the system may be provided with shock, adverse environment and mishandling resistance features, to render the system highly durable for use in a wide variety of conditions of use. Also, the system is portable, with the components adapted to be assembled and disassembled in relative ease, speed and simplicity.

### BEST MODE FOR CARRYING OUT THE INVENTION

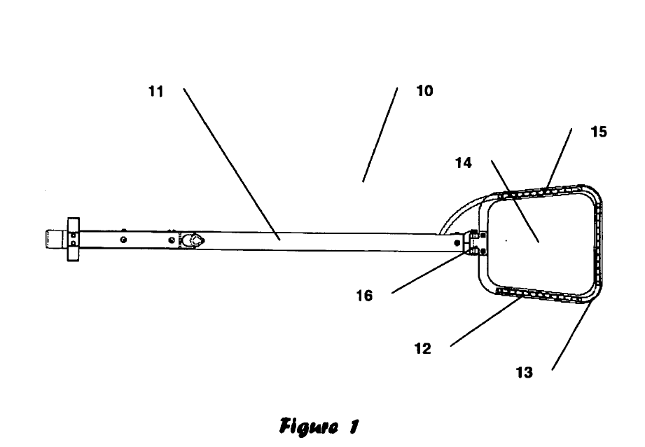

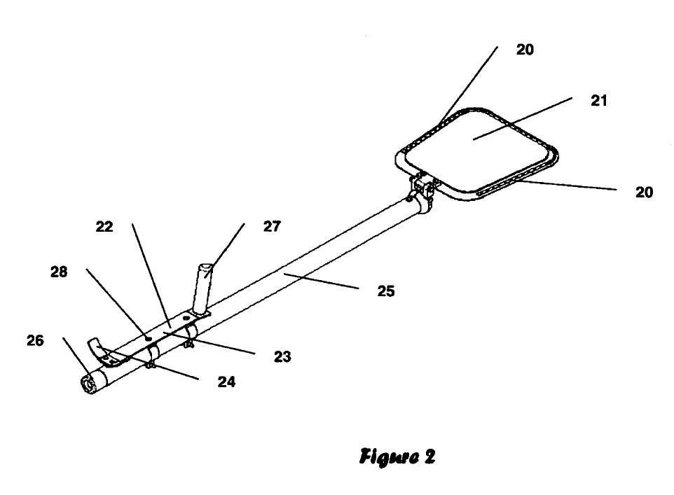

With reference to FIGS. 1 and 2, preferred embodiments of the present invention will be described.

As shown in FIG. 1, a preferred embodiment 10 of the portable security assessment device includes a hollow tubular shaft 11. Shaft 11 may be fabricated of any material having suitable strength and rigidity, such as metal, plastic or composite material, but preferably is made of 6061 aluminum tubing or material having equivalent functional strength and rigidity. The series of LED assembly 12 is adapted to be connected to the back plate 13 by any conventional means such as, for example, pressure sensitive, two-sided tape, screws, snap latch or friction fit. The preferred LEDs 12 in the visible range are surface-mount LEDs available from Kingbright Corporation of City of Industry, California, USA. The preferred LEDs 12 in the infrared or far infrared range are surface-mount LEDs available from Epitex Incorporation of Kyoto, Japan. The preferred LEDs 12 in the UV range are surface-mount LEDs available from Marubeni America Corporation of Santa Clara, Calif. 95054 USA.

As shown in FIG. 1 a flat planar reflecting surface or mirror 14 is removably affixed on the surface of back plate 13 by attachment means (not shown) such as, for example, double sided adhesive tape, hook and loop fasteners (like Velcro®) or suitable non-hardening adhesive. The essentially flat planar mirror 14 is thus easily replaceable and may be made of any suitable material, but is preferably made of a resilient plastic or polymeric material having one or more reflecting coatings or layers. The back plate 13, shown in FIG. 1 may be fabricated of any material having suitable strength and rigidity, such as metal, plastic or composite material, but preferably is made of 5052 or 6061 sheet aluminum or material having equivalent functional strength and rigidity.

With reference to FIG. 1 the mirror 14 and back plate 13 are preferably of similar geometric shape, with the mirror 14 being sized to fit within the area defined LED/PCB assemblies 15 such that in operation the perimeter of mirror 14 is bordered by the LED/PCB assemblies 15. It has been found that a preferred shape of mirror 14, and thus of back plate 13, is that of a trapezoid having its narrower end proximate the connection to flexible joint 16. A bumper or skid may be mounted on the lower or second surface of back plate 13 (not shown), preferably nearer its wider end than its narrower end of back plate 13, and preferably made of a tough polymeric material, to facilitate maneuvering and orientating of the inspection mirror 14 under a vehicle or object to be inspected when placed in contact with the ground.

With reference to FIG. 2, the entire LED/PCB assemblies 20 may be encased in a translucent or transparent protective polymeric finish jacket (not shown) to protect the LED/PCB assemblies against harsh field applications.

Although the entire LED/PCB assemblies 20 may continuously surround the mirror 14; nonetheless, it has been discovered that LED/PCB assemblies 20 intermittently separated and attached by wire 17 in FIG. 1 to each other facilitates the manufacturing process.

To facilitate increased and more uniform illumination of a preferred embodiment of the present invention, shown in FIG. 2, includes series of LEDs to be evenly distributed—the distance between the LEDs on the PCB is equal and uniform. It is noted that the LED/PCB assemblies may not be equally placed on the perimeter of the reflective surface 21. However, the LED/PCB assemblies may be connected to each other via the wires 17 conducting electricity from the battery pack to the LEDs.

Typically, in a preferred embodiment, shaft 11 of FIG. 1 has a length of about 42 inches and a diameter of about 1⅝ inches. Back plate 13 typically has a length of about 11½ inches, a narrow end width of about 9¾ inches, excepting any rounding at the corners, a wide end width of about 11¾ inches, excepting any rounding at the corners, and a thickness of about 5/100 to 10/100 inches if made of sheet aluminum.

With respect to FIG. 1, the flexible joint 16 connecting shaft 11 with back plate 13 of the present invention will be described. A feature of the flexible joint 16 is that it permits the mirror plate 13 to be easily positioned and maintained at any angle between from about 85 degrees to about 180 degrees with respect to the long axis of shaft 11. The flexible joint 16 preferably is made of a tough polymeric material having a relatively low coefficient of sliding friction such as nylon, of which Nylon 6-6 is preferred. The flexible coupling or joint 16 includes two subassemblies (not shown).

With reference now to FIG. 2, the handle assembly 22 of the present invention is shown. The handle assembly has a frame 23, a generally C-shaped arm support near one end 24, extends along shaft 25 near its proximate end 26. Handle frame 23 is preferably made of 5052 or 6061 aluminum stock, but may be fabricated of any material having suitable strength and rigidity. A hand grip 27 is mounted on handle frame 23, at its end opposite the arm support, by means of grip core mounting screw 28.

In operation, the hand-held portable security assessment device of the present invention is grasped with one hand at grip 27 by the user who rests his or her upper forearm or elbow in the C-shaped arm support of handle frame 22. When so grasped, the hand-held inspection device of the present invention is stable and easily controlled and manipulated. The ball unit 16 of FIG. 1, by reason of its particular exterior shape and low coefficient of surface friction, facilitates sliding the inspection device along the ground under a vehicle or object to be inspected. Further, the exterior shape of ball unit 16 allows the user to easily pitch and roll the inspection mirror from side to side to scan the area to be inspected while the ball unit is in contact with the ground to provide additional stability to facilitate steady viewing of the underside of a vehicle or other object. When the LEDs are energized, a first embodiment of the present invention floods the area viewed in the inspection mirror with uniform illumination to reduce shadows and contrasts and so facilitate visual inspection.

At near the proximate end 26, a switching means may be provided to turn the LEDs off or on. Similarly, a dimming means may be provided to dim the illumination level as desired.

A battery pack is located near the proximate end 26 to advantageously balance the embodiment; however, the battery pack can be located on the embodiment. Further, the battery pack can be chargeable, in which case the charging inlet can be conveniently and advantageously located anywhere on the embodiment.

It is understood that the embodiment of the present invention is also intended for use where ambient lighting is sufficient to provide illumination suitable for inspection. Of course, this embodiment may be used in such conditions without the need to energize its light source to conserve energy.

While the present invention has been described in connection with what is presently considered to be the most practical and preferred embodiments, it is to be understood that the invention is not to be limited to the disclosed embodiments, but to the contrary, is intended to cover various modifications and equivalent arrangements included within the spirit of the invention, which are set forth in the appended claims, and which scope is to be accorded the broadest interpretation so as to encompass all such modifications and equivalent structures.

1. A portable security assessment device comprising:
a power source;
light emitting diodes defining an illumination source;
the said light emitting diodes mounted on a mirror plate having a surface defining a perimeter;
a mirror mounted on said surface of said mirror plate;
said mirror plate flexibly coupled to a shaft;
said light emitting diodes disposed on said surface of mirror plate adjacent at least a portion of said perimeter; and
said light emitting diodes emit light radially in a predetermined pattern.
